(19) United States
(12) Patent Application Publication
(10) Pub. No.: US 2006/0259230 A1
(43) Pub. Date: Nov. 16, 2006

(54) Wireless additive injection system

(76) Inventors: Paul F. Waters, Washington, DC (US); John B. Waters, Washington, DC (US); Robert H. Lauchner, El Paso, TX (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/375,563

(22) Filed: Mar. 14, 2006

Related U.S. Application Data
(60) Provisional application No. 60/661,575, filed on Mar. 14, 2005.

(51) Int. Cl. G06F 19/00; F02M 25/00

(52) U.S. Cl. 701/115; 123/1 A

(57) ABSTRACT

The invention includes an additive injection system for automatically metering a liquid fuel additive into the fuel supply of a fuel-burning device. The additive injection system may be adapted to obtain a fuel value from a fuel pump to maintain a constant additive concentration in the fuel over a series of random fuel depletion and refueling cycles, such as by communicating with one or more networks in communication with the fuel pump.

### RELATED APPLICATIONS

This application claims the benefit of U.S. Provisional Patent Application Serial Number 60/661,575, titled Wireless Additive Injection System, filed Mar. 14, 2005, the contents of which are hereby incorporated by reference.

### FIELD OF THE INVENTION

The invention generally relates to an additive injection system. More specifically, the invention relates to an additive injection system adapted to communicate with a fuel pump, such as through one or more networks.

### BACKGROUND OF THE INVENTION

Fuel treatment additives are used to modify fuels, for example, to improve efficiency, increase power, and/or achieve air quality benefits. Many additives must be present in a specific concentration to have the optimum desired effect. Traditionally, such additives have been mixed into the fuel manually by measuring out the recommended quantity of additive per volume of fuel taken on at the fuel pump and pouring it into a fuel tank. This method of mixing an additive into the fuel is inconvenient, and often imprecise, due to human error or neglect. Further, the quantity of fuel added to a fuel tank has traditionally been determined from a sending unit line to a vehicle's fuel gauge. However, this is not an optimum indicator, as this method often produces erratic and unreliable measurements.

### SUMMARY OF THE INVENTION

Embodiments of the invention include a precise and reliable system for automatically metering a liquid fuel additive into the fuel supply of a fuel-burning device such as an internal combustion (IC) engine. In some embodiments the system is adapted to maintain a constant additive concentration in the fuel over a series of random fuel depletion and refueling cycles. Embodiments of the system provide several advantages, including adding a precise amount of additive to achieve a desired additive concentration in the fuel.

In some embodiments, the system determines a fuel value from data obtained from a fuel pump, rather than relying on unreliable data from a fuel tank sending unit to determine how much fuel has been added by a fuel pump. Such a system allows for maintaining a relatively stable concentration of additive in the fuel to improve the additive's performance. Further, such a system avoids requiring a user to directly calculate and measure the correct amount of additive and introduce it into the fuel system, thereby avoiding disadvantages such as user error.

The system may obtain the fuel value from the fuel pump by any suitable method. For example, the system may be placed in communication with a fuel pump through a data network. The data network may link and/or be in communication with at least one of a fleet operations center and a credit card service provider. In other embodiments, the system may be in communication with a vehicle monitoring and management system onboard subsystem. In each case, the system may obtain a data transmission indicating the amount of fuel taken on at a fuel pump, which can then be processed by the system to deliver an appropriate amount of additive to a fuel system. In such instances, the fuel value will be derived from a relatively accurate and precise fuel pump rather than derived from the relatively inaccurate and imprecise fuel tank sending unit.

### BRIEF DESCRIPTION OF THE DRAWINGS

FIG. 1 shows an environmental view of a motor vehicle provided with an additive injection system in accordance with an embodiment of the invention.

FIG. 2 shows a schematic view of an additive injection system in accordance with an embodiment of the invention.

FIG. 3 shows a schematic view of an additive injection system in accordance with an embodiment of the invention.

FIG. 4 shows a schematic view of an additive injection system in communication with one or more networks in accordance with an embodiment of the invention.

FIG. 5 shows a schematic view of an additive injection system in communication with one or more networks in accordance with an embodiment of the invention.

### DETAILED DESCRIPTION OF THE INVENTION

For the purpose of promoting an understanding of the principles of the present invention, reference will now be made to the embodiments illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

Some embodiments of the invention include an additive injection system (hereafter, “AIS” useful for delivering a fuel additive to an IC engine. The AIS may be in communication with a fuel pump to determine the amount of fuel added to a fuel tank. In some embodiments, the AIS may be in wireless communication with one or more networks which are themselves in communication with the fuel pump. As used herein, the term “fuel additive” means a substance that is added to fuel and/or employed to treat effluent derived from the combustion of fuel. For example, the fuel additive may comprise a polymer adapted to improve the combustion efficiency of a fuel-burning device.

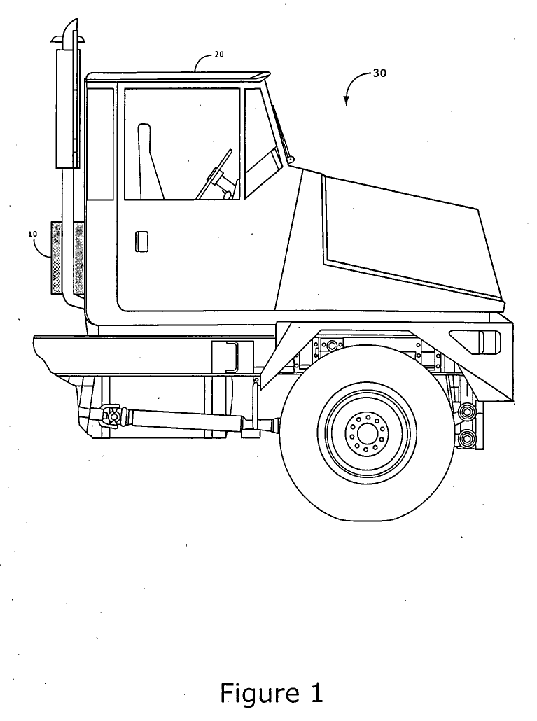

Further, the IC engine may be of any type, such as a gasoline engine, a diesel engine, a jet engine, a marine engine, a furnace, or a burner. In addition, the IC engine may be stationary (e.g., a diesel electric generator) or utilized in a vehicle. The term “vehicle” is used in its broadest sense, referring to any means in or by which something is carried or conveyed, and includes automobiles, trucks, airplanes, marine vehicles, off-road vehicles, recreational vehicles, construction equipment and the like. As an example, FIG. 1 shows an embodiment of an AIS 10 mounted on the rear of a cab 20 of a truck 30. Of course, an AIS may be mounted in any suitable location on or within a vehicle.

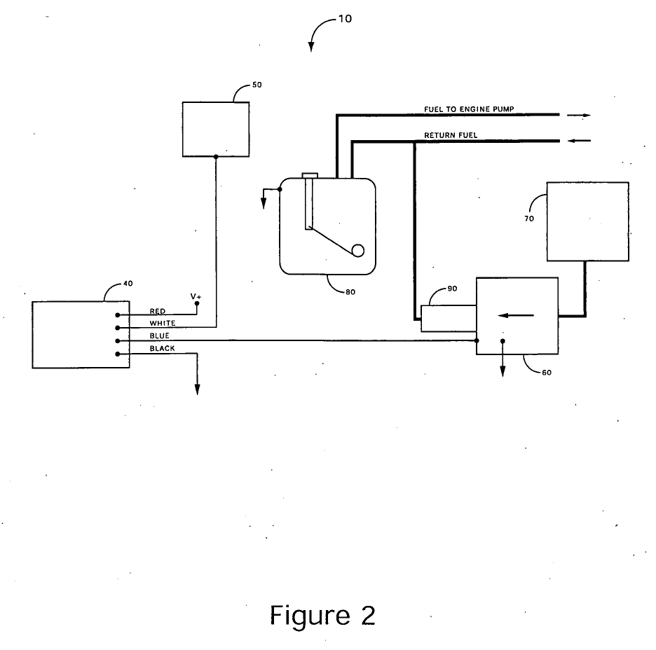

An embodiment of an AIS 10 in accordance with the invention is shown in FIG. 2. The AIS may include an additive control module 40 (hereafter, “ACM” in communication with an AIS receiver 50. The ACM may be useful for communicating information and providing commands useful for providing a correct amount of additive to a fuel system. Such communication may occur either by wire or wirelessly. In some embodiments, the AIS receiver 50 may be any appropriate device that is capable of receiving and/or sending data either by wire or wirelessly. Examples of receivers include a pager/GSM (global system for mobile communications) system and a cellular/satellite communication system. The ACM may also be in communication with an AIS pump 60. The AIS pump may be in fluid communication with an additive tank 70 and a fuel tank 80, and a valve 90 may be provided between the AIS pump and the fuel tank. Upon receiving a command, the AIS pump may pump additive from the additive tank to the fuel tank.

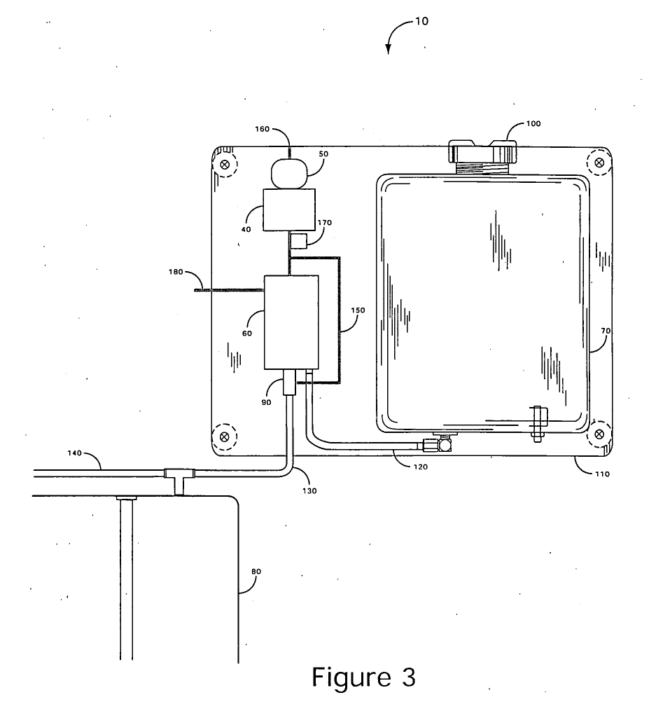

FIG. 3 shows an embodiment of an AIS in more detail. As shown, the AIS 10 may comprise an additive tank 70 to hold the additive to be injected into a fuel tank 80. The additive tank should be large enough to hold sufficient additive for several fuel depletion and refueling cycles, and should not contain a material that interacts with the additive. Further, the additive tank should be located in an area that is accessible to an operator for replenishing the additive supply. In some embodiments, the additive tank may be equipped with a temperature-control feature. Further, a cap 100 may be provided to close the additive tank. Such a cap may be vented to allow for pressure regulation. In some embodiments, various components of the AIS can be mounted to a mounting plate 110.

The additive tank may be in fluid communication with an AIS pump 60 through an additive line 120. The AIS pump may be any device capable of transferring additive from the additive tank to a fuel tank. In some embodiments, the AIS pump is a 12 Volt DC diaphragm pump. The AIS pump can transfer the additive to a fuel tank via an additive line 130 to the fuel tank. In some embodiments, the additive line to the fuel tank can feed into a return fuel line 140 feeding into the fuel tank. As shown in FIG. 3, a valve 90 may be provided between the AIS pump and the fuel tank. In some embodiments, the valve comprises a 12 Volt DC solenoid valve.

The AIS pump and valve may be controlled by an ACM 40. In some embodiments, the ACM is in physical communication (e.g., electrical) with the AIS pump and valve via a wire 150. The ACM may be any device suitable to perform its function, such as a microprocessor. In some embodiments, the ACM may include the processing, storage, and communications equipment to receive data, process data to determine an appropriate volume of additive to be delivered into a fuel system, command the AIS pump to deliver an appropriate volume of additive into a fuel system, and control any valves that may be present in the AIS. In some embodiments, the ACM may comprise a receiver 50 to receive and/or transmit data. Such a receiver may be powered by a 12 Volt DC power line. Further, the receiver may be adapted to receive communications either by wire or wirelessly.

The power requirements of the AIS may be met in any suitable way, such as connection to the power grid, single use batteries, rechargeable batteries, or using power from a vehicle's battery that is in turn charged from the IC engine. Power may be delivered to the AIS via input line 160. In the AIS shown in FIG. 3, a fuse 170 may be provided to shield the components from electrical surges. In addition, a ground connection 180 may be provided.

Such an AIS system can be installed in any suitable manner. For example, the components discussed above may be mounted to the mounting plate 110. The mounting plate may then be installed in any suitable location, such as on the rear of a cab as shown in FIG. 1. The AIS may then be connected to the vehicle's electrical system, the additive line may be directly or indirectly connected to the fuel system, and the ACM may be placed in communication with a fuel pump through one or more networks.

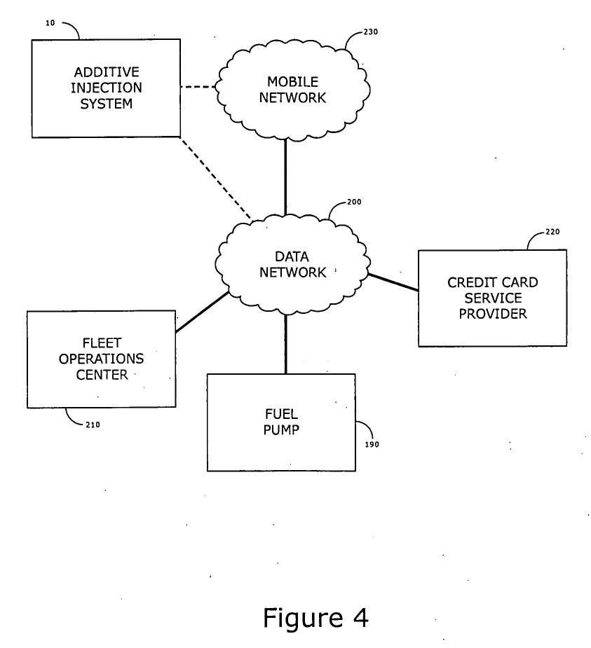

As shown in FIG. 4, the AIS 10 may be placed in communication with a fuel pump 190 to determine the amount of fuel added to the fuel tank. In the embodiments shown in FIG. 4, the AIS 10 is in communication with the fuel pump 190 through a data network 200. A data network may include, for example, a network such as the Internet. The data network may link and/or be in communication with at least one of a fleet operations center 210, the fuel pump 190, and a credit card service provider 220. In each case, the AIS may obtain a data transmission (e.g., via the AIS receiver) indicating the amount of fuel taken on at a fuel pump (hereafter, the “fuel value”, which may then be processed by the ACM to produce a command to the AIS pump to deliver an appropriate volume of additive (hereafter, the “additive value” to a fuel system. In such instances, the fuel value will be derived from a relatively accurate and precise fuel pump rather than derived from the relatively inaccurate and imprecise fuel tank sending unit.

The AIS (such as via the AIS receiver) may be in communication with the data network 200 wirelessly to obtain the fuel value. For example, the AIS may communicate with the data network through a mobile network 230. A mobile network may be, for example, a cellular telephone system or a satellite data system or an integration of a number of wireless technologies wherein connectivity over heterogeneous networks is maintained seamlessly as the user moves in and out of, for example, Wi-Fi, WWAN and LAN networks, with a single credential set. The mobile network may also include a direct wireless data link, such as a transceiver/antenna or other such direct wireless data link.

As discussed above, the data network 200 can be in communication with one or more of a fleet operations center 210, a fuel pump 190, and a credit card service provider 220. The fleet operations center 210 may include a centralized data collection and processing facility commonly operated by a trucking fleet. The fuel pump 190 may include any device adapted to meter and pump fuel, such as is commonly found at commercial gas stations, truck stops, and/or private fleet refueling facilities. Such fuel pumps are adapted to accurately measure the amount of fuel dispensed, such as by a positive displacement pump.

The credit card service provider 220 can include any operator or facilitator involved in a fueling transaction. Such credit card service providers include consumer credit card service providers who may make their credit card services available to the broad public, as well as electronic pre-authorization credit card service providers, whose credit card services are frequently used by commercial vehicle operators for automating fuel purchases and cash disbursements. As used herein, the term “credit card” (hereafter, “CC” means any instrument, including any payment instrument or credit instrument, whether physical (such as a plastic card) or not, that allows the user to generate instructions electronically (e.g., to direct the movement of deposits). The user typically authorizes such instructions by providing a signature, personal identification number (PIN), or some other form of identification. Typically, a driver makes a fuel purchase by swiping a designated CC at the fuel pump, whereupon he or she may be prompted to enter a PIN. After the driver has finished refueling, details of the transaction are typically sent electronically over a data network to a CC service provider, which may report them to a fleet operator.

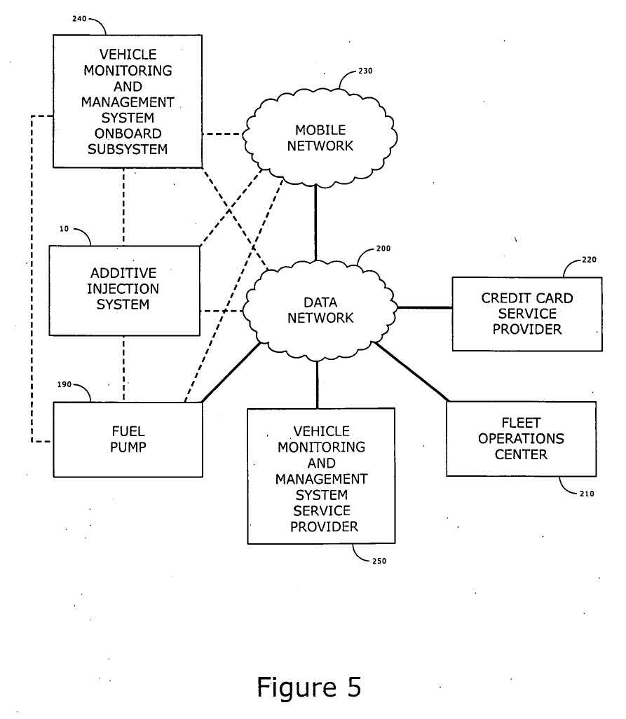

In other embodiments, such as those shown in FIG. 5, the AIS 10 may be in communication with one or more of a data network 200 (via, for example, a mobile network 230), a fuel pump 190, and a vehicle monitoring and management system onboard subsystem (hereafter “VMMSOS” 240. As shown in FIG. 5, the AIS may be in direct wireless communication with the fuel pump 190. In such embodiments, the AIS may receive the fuel value directly from the fuel pump.

Generally, a VMMSOS 240 may be used for at least one of logging, tracking, reporting information or remotely triggering operations pertaining to vehicles (e.g., fleet vehicles). The VMMSOS communication module may be any appropriate module that is capable of sending and receiving data. Examples of communication modules include a two-way pager/GSM system and a cellular/satellite communication system. An example of a VMMSOS is PeopleNet's PerformX™. Further, the AIS may communicate with the VMMSOS either by wire or wirelessly via the AIS receiver using any suitable data communications protocol.

The VMMSOS may include a communication module that is itself linked via a mobile network 230 to a data network 200. Such data networks may link one or more of a VMMSOS service provider 250 (such as a centralized base station or a branch station of the VMMSOS), a fleet operations center 210, a fuel pump 190, and a credit card service provider 220.

Various examples of data transfer pathways in accordance with embodiments of the invention will now be described. FIG. 4 illustrates data transfer pathways of an embodiment of the invention. For example, in FIG. 4, an AIS may be linked via a mobile network to a data network, to which one or more of a fleet operations center, a fuel pump, and a CC service provider is also linked. The CC service provider obtains data with respect to a vehicle operator's fuel purchase through, for example, one of a network of credit-card-terminal-equipped or connected fuel pumps the CC service provider is in communication with over a data network. The CC service provider may make the fuel purchase data available over a data network to the carrier's fleet operations center.

In such an embodiment, when the driver of the vehicle completes a transaction for the purchase of fuel using, for example, a self-identifying fuel card, the fuel value is sent, preferably in substantially real time, from the fuel pump over a data network to a CC service provider and back over a data network to a mobile network; and then, via the AIS receiver, to the ACM, where the fuel value is processed to produce a command for the AIS pump to trigger the additive value. The ACM may then command the AIS pump to deliver the additive value into the fuel system.

FIG. 5 shows a block diagram of an AIS in communication with a VMMSOS. As shown, the AIS may connect to a VMMSOS, and the VMMSOS may be linked via a mobile network to a data network. From the data network, the AIS may ultimately be linked to a vehicle monitoring and management system service provider, a fleet operations center, and a CC service provider and a network of fuel pumps.

In some embodiments, the fuel value is sent from the fuel pump, preferably in substantially real time, over a data network to a CC service provider and back over a data network to a vehicle monitoring and management system service provider and back over a data network to a mobile network to a VMMSOS and then, whether wirelessly or over a conventional wire, via an AIS receiver, to the ACM, where the fuel value is processed to produce a command for the AIS pump to trigger the additive value. The ACM may then command the AIS pump to deliver the additive value into the fuel system.

In some embodiments the fuel value is sent from the fuel pump, preferably in substantially real time, over a data network to a CC service provider, where it is processed to produce a command for the AIS pump to trigger the additive value, which command is sent over a data network to a mobile network and, via an AIS receiver, to the ACM. The ACM may then command the AIS pump to deliver the additive value into the fuel system.

In other embodiments, the fuel value is sent from the fuel pump, preferably in substantially real time, over a data network to a CC service provider, where it is processed to produce a command for the AIS pump to trigger the additive value, which command is sent over a data network to a vehicle monitoring and management system service provider and back over a data network to a mobile network to a VMMSOS and then, whether wirelessly or over a conventional wire, via an AIS receiver, to the ACM. The ACM may then command the AIS pump to deliver the additive value into the fuel system.

Further referring to FIG. 5, in some embodiments the fuel value is sent from the fuel pump, preferably in substantially real time, over a data network to a CC service provider and back over a data network to a vehicle monitoring and management system service provider, where it is processed to produce a command for the AIS pump to trigger the additive value, which command is sent back over a data network to a mobile network to a VMMSOS and then, whether wirelessly or over a conventional wire, via an AIS receiver, to the ACM. The ACM may then command the AIS pump to deliver the additive value into the fuel system.

In some embodiments the fuel value is sent from the fuel pump, preferably in substantially real time, over a data network to a CC service provider and back over a data network to a vehicle monitoring and management system service provider and back over a data network to a mobile network to a VMMSOS, where it is processed to produce a command for the AIS pump to trigger the additive value, which command is sent, whether wirelessly or over a conventional wire, via an AIS receiver, to the ACM. The ACM may then command the AIS pump to deliver the additive value into the fuel system.

In other embodiments the fuel value is sent from the fuel pump to the AIS where it is processed to produce a command for the AIS pump to trigger the additive value. The AIS may then command the AIS pump to deliver the additive value into the fuel system.

In some embodiments the fuel value is sent from the fuel pump in real time over a mobile network to the AIS, where it is processed to produce a command for the AIS pump to trigger the additive value. The AIS may then command the AIS pump to deliver the additive value into the fuel system.

In other embodiments the fuel value is sent from the fuel pump in real time over a direct wireless data link, via an AIS receiver to the ACM, where it is processed to produce a command for the AIS pump to trigger the additive value. The ACM may then command the AIS pump to deliver the additive value into the fuel system.

In some embodiments the fuel value is sent from the fuel pump in real time over a data network and a mobile network to the AIS, where it is processed to produce a command for the AIS pump to trigger the additive value. The AIS may then command the AIS pump to deliver the additive value into the fuel system.

With further reference to FIG. 5, in some embodiments the fuel value is sent from the fuel pump in real time over a direct wireless data link, via a VMMSOS receiver, to the VMMSOS, which relays this fuel value, whether wirelessly or over a conventional wire, via an AIS receiver, to the ACM. The ACM then processes the fuel value to produce a command for the AIS pump to trigger the additive value. The ACM may then command the AIS pump to deliver the additive value into the fuel system.

In other embodiments, the fuel value is sent from the fuel pump in real time over a data network to a CC service provider, where it is processed to produce a command for the AIS pump to trigger the additive value, which command is then sent back over a data network to the fuel pump, from which it is sent in real time over a direct wireless data link, via an AIS receiver, to the ACM. The ACM may then command the AIS pump to deliver the additive value into the fuel system.

In some embodiments, the fuel value is sent from the fuel pump, in real time, over a data network to a CC service provider and back over a data network to a vehicle monitoring and management system service provider, where it is processed to produce a command for the AIS pump to trigger the additive value, which command is sent back over a data network to the fuel pump from which it is sent in real time over a direct wireless data link, via an AIS receiver, to the ACM. The ACM may then command the AIS pump to deliver the additive value into the fuel system.

With further reference to FIG. 5, in some embodiments the fuel value is sent from the fuel pump, in real time, over a data network to a CC service provider and back over a data network to a vehicle monitoring and management system service provider, where it is processed to produce a command for the AIS pump to trigger the additive value, which command is sent back over a data network to the fuel pump from which it is sent in real time over a direct wireless data link to a VMMSOS receiver, which relays this command, wirelessly or over a conventional wire, via an AIS receiver to the ACM. The ACM may then command the AIS pump to deliver the additive value into the fuel system.

Such embodiments of the invention as described above include a precise and reliable system for automatically metering a liquid fuel additive into the fuel supply of a fuel-burning device such as an IC engine.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations, which fall within the spirit and broad scope of the invention.

What is claimed is:

1. An additive injection system comprising an additive control module to deliver an additive to a fuel system of a fuel-burning device, the additive injection system being in communication with a fuel pump to receive a fuel value.

2. The additive injection system of claim 1, wherein the additive injection system and the fuel pump are both in communication with a data network.

3. The additive injection system of claim 1, wherein the additive injection system and the fuel pump are both in communication with a data network, and the additive injection system is in communication with the data network through a mobile network.

4. The additive injection system of claim 1, wherein the additive control module is in communication with a receiver.

5. The additive injection system of claim 1, wherein the additive control module is adapted to read the fuel value from a data network.

6. The additive injection system of claim 1, wherein the additive control module is adapted to calculate an additive value from the fuel value and command a pump to deliver an appropriate amount of the additive into the fuel system.

7. The additive injection system of claim 1, wherein the additive control module is in communication with a vehicle monitoring and management system onboard subsystem.

8. The additive injection system of claim 1, wherein the additive injection system includes a receiver adapted to enable the additive control module to wirelessly communicate with a data network.

9. The additive injection system of claim 1, wherein the additive injection system and the fuel pump are both in communication with a data network and the data network is in communication with at least one of the group consisting of a vehicle monitoring and management system service provider, a fleet operations center, and a credit card service provider.

10. The additive injection system of claim 1, wherein the fuel-burning device is an internal combustion engine.

11. A method of delivering an additive into a fuel system comprising providing an additive injection system having an additive control module, obtaining a fuel value from a fuel pump, and delivering an appropriate volume of the additive to a fuel system of a fuel-burning device.

12. The method of claim 11, wherein the additive injection system and the fuel pump communicate through a data network.

13. The method of claim 11, wherein the additive injection system and the fuel pump communicate through a data network, and the additive injection system communicates with the data network through a mobile network.

14. The method of claim 11, wherein the additive control module communicates with a receiver.

15. The method of claim 11, wherein the additive control module reads the fuel value from a data network.

16. The method of claim 11, wherein the additive control module calculates an additive value from the fuel value and commands a pump to deliver an appropriate volume of the additive into the fuel system.

17. The method of claim 11, wherein the additive control module communicates with a vehicle monitoring and management system onboard subsystem.

18. The method of claim 11, wherein the additive injection system includes a receiver to enable the additive control module to wirelessly communicate with a data network.

19. The method of claim 11, wherein the additive injection system and the fuel pump both communicate with a data network and the data network communicates with at least one of the group consisting of a vehicle monitoring and management system service provider, a fleet operations center, and a credit card service provider.

20. An additive injection system comprising an additive control module to add an appropriate volume of an additive to a fuel system of a fuel-burning device, the additive injection system comprising a receiver in wireless communication with a data network, the data network being in communication with a fuel pump to receive a fuel value.

21. The additive injection system of claim 20, wherein the additive injection system is in communication with the data network through a mobile network.

22. The additive injection system of claim 20, wherein the additive control module is adapted to calculate an additive value from the fuel value and command a pump to deliver an appropriate volume of the additive into the fuel system.

23. The additive injection system of claim 20, wherein the additive control module is in communication with a vehicle monitoring and management system onboard subsystem.

24. The additive injection system of claim 20, wherein the data network is in communication with at least one of the group consisting of a vehicle monitoring and management system service provider, a fleet operations center, and a credit card service provider.

25. The additive injection system of claim 20, wherein the fuel-burning device is an internal combustion engine
